(19) United States
(12) Patent Application Publication
(10) Pub. No.: US 2009/0287991 A1
(43) Pub. Date: Nov. 19, 2009

(54) GENERATION OF FUSIBLE SIGNATURES FOR FUSION OF HETEROGENOUS DATA

(75) Inventors: Grant C. Nakamura, Kennewick, WA (US); Shawn J. Bohn, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute

(21) Appl. No.: 12/122,994

(22) Filed: May 19, 2008

(51) Int. Cl. G06F 15/00

(52) U.S. Cl. 715/210

(57) ABSTRACT

Methods, computer-executable instructions on computer-readable media, and systems for generating fusible signatures for information contained in two or more corpora of data. The fusible signatures can allow the information from the separate corpora of data to be merged, or fused, into a single information space that allows information analysts to explore, analyze, and/or further process the fused data. Prior to manipulation by the embodiments of the present invention, the information contained in at least one of the individual corpora of data is typically represented by initial signatures that are not directly fusible with information in the other corpora of data because of differences, for example, in dimensionality, source, data type, basis, and/or the space in which the initial signatures reside.

### STATEMENT REGARDING FEDERALLY SPONSORED RESEARCH OR DEVELOPMENT

This invention was made with Government support under Contract DE-AC0576RL01830 awarded by the U.S. Department of Energy. The Government has certain rights in the invention.

### BACKGROUND

In the context of information analysis, analysts are challenged not only by the vast amounts of data that they must sift and refine, but also by the different types and sources of data that they must reconcile. For example, data requiring analysis can be in the form of text, imagery, audio, maps, sensor data, and others, and can come from any variety of sources including, but not limited to, the Internet, media outlets, telephone conversations, the intelligence community, and digital communications. During the analysis process, effective analysts fuse relevant information and identify connections between the seemingly disparate data. However, oftentimes, the fusion process is performed manually and the analyst is required to juggle in his/her mind various pieces of data. In the least, information loss and traceability in developing the analytic product can occur as a result.

Analysts having an effective fusion solution can focus on exploring and analyzing data, rather than integrating it. Accordingly, a need for automated approaches and tools for generating fusible signatures of information contained in two or more corpora of data exists.

### SUMMARY

Embodiments of the present invention include methods, computer-executable instructions on computer-readable media, and systems for generating fusible signatures for information contained in two or more corpora of data. The fusible signatures can allow the information from the separate corpora of data to be merged, or fused, into a single information space that allows analysts to explore, analyze, and/or process the fused data. Prior to manipulation by the embodiments of the present invention, the information contained in at least one of the individual corpora of data is typically represented by initial signatures that are not directly fusible with information in the other corpora of data because of differences, for example, in dimensionality, source, data type, basis, and/or the space in which the initial signatures reside.

While a variety of embodiments of the present invention are contemplated, in a preferred embodiment, two or more corpora of data that are of interest each comprise documents characterized by initial signatures. A set of reference points is determined for each corpus of data, and all of the sets have the same number of reference points. Each reference point is characterized by a reference signature, and each reference point has an equivalent reference point in the other sets as determined by pre-defined criteria. A similarity measure can then be quantified for each combination of one initial signature from a given corpus of data with one reference signature from its associated set of reference points. The similarity measure represents the similarity between the initial signature and the reference signature. A fusible signature having a dimensionality equal to the number of reference points is generated by populating a vector for each document, wherein the vector for a given document comprises all of the similarity measures quantified from combinations involving the initial signature for the given document. In some embodiments, a new signature, which is also fusible, is generated for each reference signature in the same manner. The new reference signature is referred to herein as a fusible reference signature.

As used herein, a “document” refers to the smallest information unit that is represented by a signature. Documents are not limited to information in the form of text, but can broadly include audio, video, imagery, map, sensor data, and other forms of information that can be represented by a signature.

A collection of documents is referred to as a corpus of data. A corpus of data does not have to be static, but can be dynamic, evolving over time as information is added or removed. An example of a dynamic corpus of data can be a real-time stream of data. Each corpus of data exists in an information space. An information space is a set of information encoded into a specific representation. The information space for dynamic corpora can either evolve with the data or it can remain static in a static context based, for example, on features of importance. It is important to note that, an information space is not necessarily a mathematical construct in the same way as a signature space or vector space. A signature space is an information space in which the representations are signatures. Similarly, a vector space is an information space in which the representations are vectors.

“Signatures” refer to mathematical representations of documents that characterize aspects of the documents (e.g., content, semantic significance, object properties or features, etc.) and allow for computational analysis and/or visualization of the documents. An exemplary signature can comprise an N-dimensional vector representing, in signature space, a document on a semantic basis. However, not all signatures are necessarily vectors, nor are they necessarily based on semantics. The initial signatures can have a basis including, but not limited to, temporal, sentiment, events/activities, transactions, geospatial, and network topologies. Fusible signatures, as used herein, are ones that have been transformed from their original dimensionality, space, and/or basis, which may have been initially different, into ones that can be directly fused into a common dimensionality, space, and/or basis. For example, without transformation, initial signatures from a first corpus of data may not be fusible with initial signatures from a second corpus of data because they differ in terms of dimensionality, meaning, basis, the type of data represented by the initial signature, and/or the information space in which the signatures reside. However, according to the embodiments described elsewhere herein, the initial signatures can be transformed into a common form that is fusible.

“Reference points” are objects represented by reference signatures in the same information space as their associated initial signatures. According to pre-defined criteria, reference points in one set have corresponding and equivalent reference points in each of the other sets, which provides an ability to join, or fuse, the separate corpora of data together as described elsewhere herein. For purposes of conceptual clarification, but not for determination of the scope of the invention, the collective sets of reference points can be viewed metaphorically as a Rosetta stone. The equivalence between reference points across sets provides points of commonality across the information spaces containing the corpora of data to enable fusion. Exemplary reference points can, but do not necessarily, comprise documents within a corpus of data. The origin in three-dimensional space can serve as a weak analogy of reference points for two different data sets, whether or not a data point exists in one of the two data sets.

“Similarity measures” and “difference measures” as used herein, refer to types of statistical distance measures. Examples of statistical distance measures can include, but are not limited to, Euclidean, Mahalonobis, and Bhattacharyya distances. In the context of vectors as signatures, similarity can be quantified, for example, using distances or cosine measures between vectors.

In some embodiments, the fusion of the corpora of data can be accomplished using the fusible signatures as well as representations of relationships between the reference points. More specifically, for each set of reference points, a representation of relationships between the reference points in the set is constructed, wherein the representations are based on the respective fusible reference signatures. Furthermore, distances between fusible signatures and fusible reference signatures are determined in a space containing the fusible signatures. The separate representations of relationships are joined into a combined representation while altering at least one value in at least one reference signature to minimize difference measures between equivalent reference signatures. The documents are arranged in the combined representation according to each document's fusible signature while altering at least one value in at least one fusible signature to minimize changes to the distances between fusible signatures and fusible reference signatures previously determined. A new vector can then be populated for each document to generate a fused signature. The new vector for a given document comprises values from the fusible signature of the given document after the document had been arranged in the combined representation and the fusible signature had been altered as necessary to enable its arrangement in the combined representation. The fused signature (i.e., the new vector) replaces the initial signature as the representation of the document.

Representations of relationships, as used herein, can refer to computer-implemented constructs that describe relationships among signatures. Accordingly, one example of a representation includes graphs and/or the data structures representing them. Exemplary data structures can include, but are not limited to, list structures, matrix structures, and combinations thereof. In a particular embodiment, a graph is N-dimensional and can use N-dimensional signatures, wherein nodes represent the signatures, and the spacing between nodes is related according to a known function (e.g., proportional) to the similarity between documents represented by the signatures. In embodiments where the representations of relationships are graphs, the individual representations can be joined into a combined representation using one or more graph algorithms. Exemplary and appropriate graph algorithms can include, but are not limited to, force-based algorithms, neural network algorithms, self-organizing map (SOM) algorithms, simulated annealing algorithms, and genetic algorithms. Generally, appropriate algorithms optimize an objective function, which, for the present embodiment, is to reduce the stresses and/or errors in the graph layout. Alternative objective functions can include, but are not limited to, maintaining neighborhoods and maintaining global structures.

The purpose of the foregoing summary is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The summary is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. The preceding and following descriptions show and describe preferred embodiments of the invention by way of illustration. As will be realized, the invention is capable of modification in various respects without departing from the invention. Accordingly, the drawings and descriptions of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 is an illustration depicting the generation of fusible signatures, and the fusion, of two different corpora of data according to one embodiment of the present invention.

FIG. 2 is an illustration depicting a visualization of a corpus of data.

FIG. 3 is an illustration depicting a visualization of a corpus of data.

FIG. 4 is an illustration depicting a visualization of the fused signatures.

### DETAILED DESCRIPTION

The description provided herein includes the best mode of one embodiment of the present invention. It will be clear from this description of the invention that the invention is not limited to these illustrated embodiments, but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

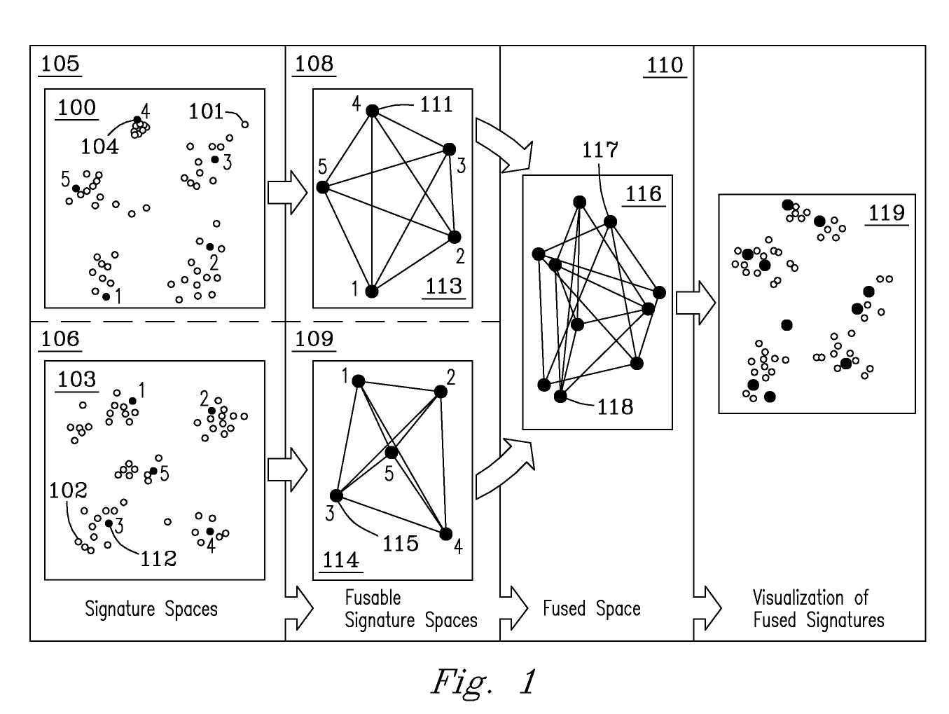

FIGS. 1-4 present graphically a variety of embodiments and/or aspects of the present invention. Referring first to FIG. 1, an illustration depicts an embodiment of the present invention wherein fusible signatures are generated for two different corpora of data and are then fused into a single space. Initially, each of the two corpora of data comprises a plurality of documents characterized by initial signatures, which are represented by dots 101, 102 in their respective visualizations 100, 103. The initial signatures from one corpus of data exist in a signature space 105 that is different than the signature space 106 of the initial signatures from the other corpus of data. Five reference points 104, 112 have been pre-defined and are numbered 1 through 5. Equivalent reference points between the sets of reference points are assigned the same number label. Several criteria have been applied in selecting the reference points. For example, the signature spaces 105, 106 will have specific dimensionalities, and the number of reference points must be at least one more than the maximum dimensionality of either of the signature spaces. Furthermore, the reference points should ideally span both spaces. In other words multiple reference points should not be substantially co-located (e.g., characterize similar aspects) because in that instance, they will likely not provide the resolution necessary to generate fusible signatures that accurately represent the documents in the corpora of data.

One way to minimize the occurrence of co-located reference points is to compute both signature spaces with a set of reference points of desire and then use a mapping of clusters to determine whether the reference points reflect the diversity of the spaces or whether additional reference points are needed in certain areas. An alternative approach involves examining the reference points in relation to the initial signatures and each respective space and identifying those reference points that maximize the values in all the dimensions. Once a base set of reference points is determined, it can be increased, as appropriate, to be a distribution of the signature spaces.

Having selected the two sets of reference points and defined their equivalents, the initial signatures can be transformed into fusible signatures. The transformation can involve defining an order for each of the reference points that becomes a definition of the dimensions in new spaces containing the fusible signatures. The similarity measures are then quantified for each initial signature-reference signature combination. In other words, for a given initial signature representing a document in one of the corpora of data, similarities are quantified to each of the reference points in the corresponding set. The quantification occurs for every document in both corpora of data with respect to the corresponding set of reference data. Accordingly, each document has five similarity measures that characterize the similarity of that document to the five reference points in the corresponding set. The fusible signature is populated with the five similarity measures in the order defined previously.

The same approach is taken to transform the reference signatures from their respective signature spaces 105, 106 into the fusible signature spaces 108, 109. In other words, similarity measures are quantified for each reference signature with respect to all of the reference signatures in the same set. For example, the fusible reference signature of a particular reference point comprises similarity measures from its reference signature to all five of the reference signatures in its set. The similarity measures are then used to populate a fusible reference signature 111 in the order defined previously for the fusible signatures. Accordingly, one similarity measure in each of the fusible reference signatures will indicate complete similarity because each reference signature is completely similar to itself. As used herein, reference signatures after being transformed into the space containing fusible signatures, are referred to as fusible reference signatures.

Whereas the initial signatures 101, 102 in the two corpora of data were different based on dimensionality, the space in which they existed, and/or on their basis, the fusible signatures have been transformed to enable fusion, where common operators (e.g., visualizations, QBE, etc.) can still apply and synergies between datatypes can be exploited. It is significant to note that extensive knowledge databases are not required, but only the documents within the corpora of data, and their initial signatures.

Having transformed the initial signatures 101, 102 and the reference signatures 104, 112 into fusible signatures and fusible reference signatures, respectively, the corpora of data can now be merged, or fused. Referring still to the embodiment illustrated in FIG. 1, graphs 113, 114 can be constructed for each set of reference points reflecting the distances between reference points in their respective fusible signature spaces. For each corpus of data, distances between fusible signatures and reference signatures are determined in the spaces 108, 109 containing the fusible signatures. Accordingly, in one respect, the two graphs represent the layout in their respective fusible signature spaces. The graphs are then joined at equivalent reference points by applying a non-linear mapping based on a forced directed layout graph algorithm, thereby creating a single, combined graph 116. Regardless of the particular graph algorithm applied, the fundamental aim is to rearrange the layout of both fusible signature spaces such that equivalent reference points, as represented by fusible reference signatures, between the two sets are proximally located, or even co-located, while maintaining the relationships between reference points within each set. Once the fusible reference signatures have been arranged, the fusible signatures are laid out against the combined graph using the same, or a similar, graph algorithm. While laying out the fusible signatures on the combined graph, only the fusible signatures are allowed to move (i.e., fusible signature values are allowed to change) against the fusible reference signatures, which are now fixed, in order to minimize changes to the distances between fusible signatures and reference signatures. After being joined, the fixed, fusible reference signatures are referred to as fused reference signatures and represented 117, 118 on the combined graph. Regardless of the particular graph algorithm applied to layout the fusible signatures on the combined graph, the fundamental aim of allowing at least some values within at least some fusible signatures to be altered is to maintain relationships between the fusible signatures and the fused reference signatures, as the relationships were first determined in the context of the fusible signatures and the fusible reference signatures. The final state of the fusible signatures, having been altered as necessary for optimal arrangement on the combined graph, become fused signatures. The fused signatures from both corpora of data are now in a common basis, exist in the same space, and have the same dimensionality. Furthermore, they can be used in a multitude of analytic and visualization processes. For example, clustering and visualization processes can be applied to generate a two-dimensional representation 119 of the documents and reference points according to the fused signatures and the fused reference signatures, respectively.

### Example

### Generation of Fusible Signatures, and Fusion, of English and Spanish Texts

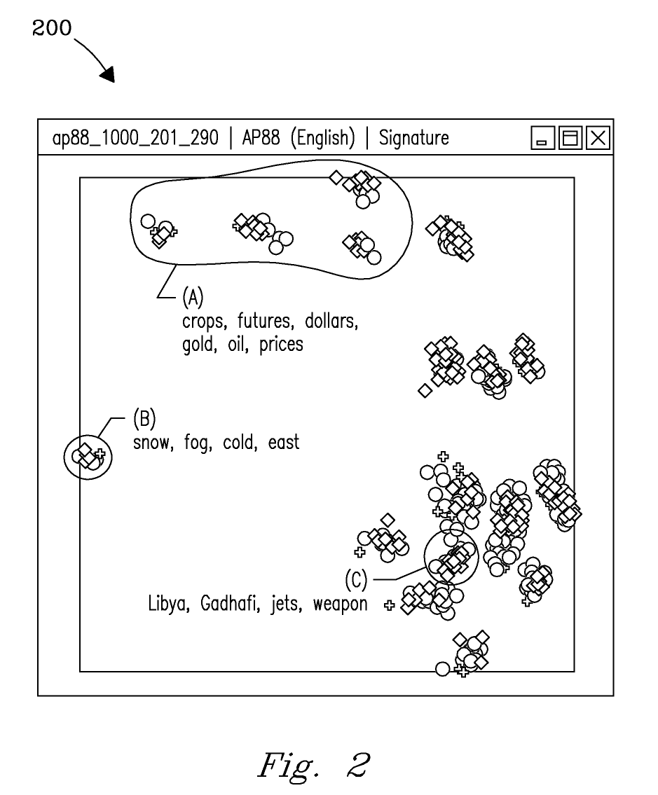

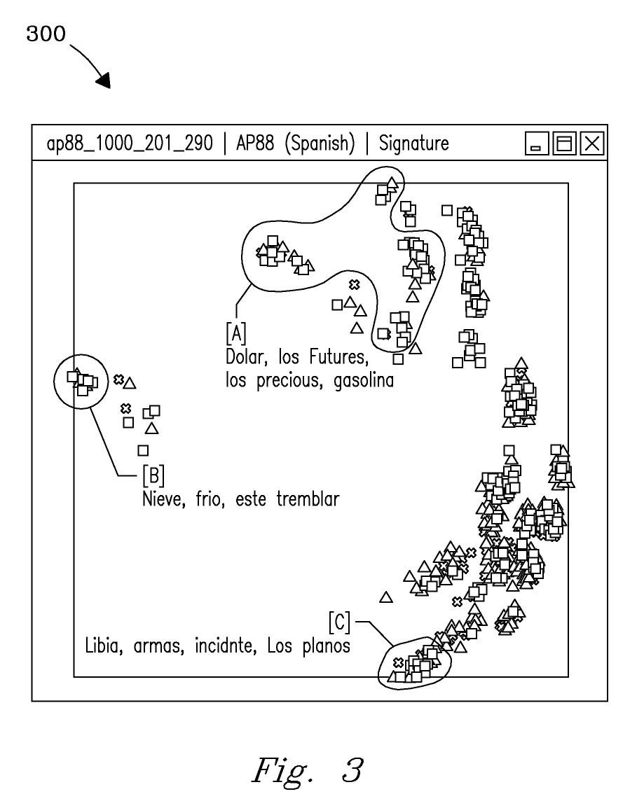

Fusible signatures were generated, and subsequently fused, from two different corpora of data comprising English and Spanish documents. The corpora of data 200, 300 were both generated from a set containing 2228 Associated Press English news stories from 1988 (AP88). The news stories were translated into Spanish by a machine translator. The English corpus 200 and the Spanish corpus 300 each totaled 1000 news stories, wherein each news story comprised a document. However, only 710 documents in each corpus were direct translations of each other. The remaining 290 documents in each corpus were not corresponding translations of each other, but were judged to be similar based on characterizing and clustering of the entire 2228 English news stories. The two corpora are depicted as clustered visualizations in FIGS. 2 and 3, respectively. Signatures for the documents in both corpora were generated using a term-frequency-multiplied-by-inverse-document-frequency (TF-IDF) approach. The resultant initial signatures had a dimensionality of 200 (i.e., N=200).

Embodiments of the present invention were then applied to the corpora of data by first identifying an ordered list of N+1 (e.g., 201) reference point pairs of documents from the test corpora. Each pair consisted of an English document and a Spanish document. The corresponding English and Spanish documents were defined as equivalent reference points spanning the two corpora of data. Since each document had one associated initial signature, it follows that each reference point had two associated reference signatures, one relevant for the English corpus and one relevant for the Spanish corpus.

As part of selecting reference points, k-means clustering was performed to cluster each corpus's signatures. The reference points were then chosen such that each cluster contained at least one reference signature associated with a reference point. Additional reference points and their associated reference signatures were chosen to meet the minimum desired number of pairs (e.g., 201) for the sets of reference points. This approach to choosing reference points ensured that the reference points were well distributed within the information spaces of the corpora of data, thereby minimizing significant repetition of content among reference points.

From each document's initial signature vector, which was generated by the TF-IDF approach, a new signature vector was derived consisting of rank-ordered distances of the initial signature to each reference point's relevant reference signature. Distances between initial signatures and reference signatures were determined according to a Euclidean distance measure. The resultant “fusible” signatures comprised vectors all having a common representational basis (i.e., rank-ordering from reference points). Fusible signatures of the reference points were similarly generated.

A refined fusion of the fusible signatures was then performed using a graph layout strategy. The fusible vectors for the reference points were used as nodes in two mathematical graphs, one for the English corpus and one for the Spanish corpus. Each reference point pair was represented by two nodes, one corresponding to the English document and its fusible reference vector, and one corresponding to the Spanish document and its fusible reference vector. The nodes were considered to be located in a vector space, with their fusible vectors being coordinates in their respective spaces. An edge was added to connect each English-Spanish reference point pair. Edges were also added between all pairs of English nodes and all pairs of Spanish nodes.

Target lengths were then associated with each edge. For intra-language edges (e.g., within each set of reference points), the target length was the initial length (i.e., distance between the nodes). For the inter-language edges (e.g., spanning the sets of reference points), the target length was zero, since the goal in applying the layout algorithm was to have each reference point's two nodes pulled together, since they were previously defined as being equivalent.

To optimize the node positions, a force-directed graph layout algorithm was employed, wherein each edge of the graph was treated as an idealized spring with force proportional to the difference between its actual length and its target length. These simulated forces were applied to nodes, causing them to be repositioned, thereby modifying the lengths of edges between nodes. A fixed number of iterations of this algorithm was executed, and then the actual length of the English-Spanish edges was measured. Had any actual length exceeded an arbitrary preset maximum tolerance, that edge would have been removed prior to resuming the iterations. The repositioned fusible reference signature was considered to be a fused reference signature.

Having fused all of the fusible reference signatures into a common graph, all of the fusible signatures representing the documents in the corpora were added in the same fashion, as nodes in the common graph. For each fusible signature, edges were added to all relevant reference point nodes (e.g., from an English fusible signature node to an English fused reference point node). The target lengths for these edges were the actual node-to-node distances in the English-only or Spanish-only graph.

The same force-directed graph layout algorithm was then applied to the new nodes and edges, again treating each new edge as an idealized spring. The existing reference point nodes and edges were held in fixed positions, and simulated forces were applied to the new nodes and edges. Again, a fixed number of iterations were executed. The final vector space coordinates of the nodes were considered to be the fused signatures.

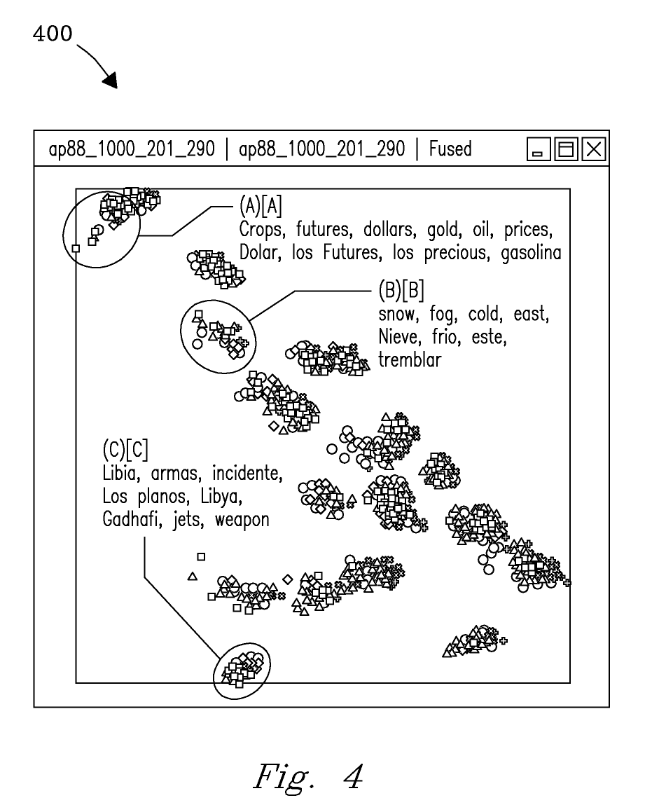

The final vectors were clustered to verify that corresponding English-Spanish documents were occurring in the same clusters at a rate significantly higher than what would be expected from random grouping. The clustered visualization 400 is depicted in FIG. 4.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A method for generating fusible signatures for documents contained in two or more corpora of data, wherein each document is characterized by an initial signature, the method comprising:
determining a set of reference points for each corpus of data, all of the sets having the same number of reference points, each reference point being characterized by a reference signature, and each reference point having an equivalent reference point in the other sets as determined by pre-defined criteria;
quantifying a similarity measure for each combination of one initial signature from a given corpus of data with one reference signature from the associated set of reference points, wherein the similarity measure represents the similarity between the initial signature and the reference signature; and
populating a vector for each document to generate a fusible signature having a dimensionality equal to the number of reference points, wherein the vector for a given document comprises all of the similarity measures quantified from combinations involving the initial signature for the given document.

2. The method of claim 1, wherein a type of data contained in a corpus of data is selected from the group consisting of text, imagery, audio, video, maps, and sensor data.

3. The method of claim 1, wherein at least two corpora of data differ, one from another, in the type of data contained therein.

4. The method of claim 1, wherein the initial signatures characterize the documents in at least one of the corpora of data on a semantic basis.

5. The method of claim 1, wherein one or more of the reference points in a set are not documents in the respective corpus of data.

6. The method of claim 1, wherein content in one or more of the corpora of data is dynamic.

7. The method of claim 6, wherein at least one corpus of data comprises streaming data.

8. The method of claim 1, wherein the number of reference points is at least one greater than the dimensionality of the largest initial signature.

9. The method of claim 1, wherein said quantifying is based on a statistical distance measure.

10. The method of claim 1, further comprising:
constructing, for each set of reference points, a representation of relationships between the reference points that is based on fusible reference signatures;
determining distances between fusible signatures and fusible reference signatures;
joining the representations into a combined representation while altering at least one value in at least one fusible reference signature to minimize difference measures between equivalent fusible reference signatures;
arranging documents in the combined representation according to each document's fusible signature while altering at least one value in at least one fusible signature to minimize changes to the distances; and
populating a new vector for each document to generate a fused signature, wherein the new vector for a given document comprises values from the given document's fusible signature after said arranging.

11. The method of claim 10, wherein the representation of relationships is a graph.

12. The method of claim 11, wherein the joining is based on a forced directed layout graph algorithm.

13. A computer-readable medium having computer-executable instructions for performing a method of generating fusible signatures for documents contained in two or more corpora of data, wherein each document is characterized by an initial signature, the method comprising:
determining a set of reference points for each corpus of data, all of the sets having the same number of reference points, each reference point being characterized by a reference signature, and each reference point having an equivalent reference point in the other sets as determined by pre-defined criteria;
quantifying a similarity measure for each combination of one initial signature from a given corpus of data with one reference signature from the associated set of reference points, wherein the similarity measure represents the similarity between the initial signature and the reference signature; and
populating a vector for each document to generate a fusible signature having a dimensionality equal to the number of reference points, wherein the vector for a given document comprises all of the similarity measures quantified from combinations involving the initial signature for the given document.

14. The computer-readable medium of claim 13, further comprising computer-executable instructions for performing a method comprising:
constructing, for each set of reference points, a representation of relationships between the reference points that is based on fusible reference signatures;
determining distances between fusible signatures and fusible reference signatures;
joining the representations into a combined representation while altering at least one value in at least one fusible reference signature to minimize difference measures between equivalent fusible reference signatures;
arranging documents in the combined representation according to each document's fusible signature while altering at least one value in at least one fusible signature to minimize changes to the distances; and
populating a new vector for each document to generate a fused signature, wherein the new vector for a given document comprises values from the given document's fusible signature after said arranging.

15. A system for generating fusible signatures for documents contained in two or more corpora of data, wherein each document is characterized by an initial signature, the system comprising a processor configured to:
determine a set of reference points for each corpus of data, all of the sets having the same number of reference points, each reference point being characterized by a reference signature, and each reference point having an equivalent reference point in the other sets as determined by pre-defined criteria;
quantify a similarity measure for each combination of one initial signature from a given corpus of data with one reference signature from the associated set of reference points, wherein the similarity measure represents the similarity between the initial signature and the reference signature; and
populate a vector for each document to generate a fusible signature having a dimensionality equal to the number of reference points, wherein the vector for a given document comprises all of the similarity measures quantified from combinations involving the initial signature for the given document.

16. The system of claim 15, wherein the processor is further configured to:
construct, for each set of reference points, a representation of relationships between the reference points that is based on fusible reference signatures;
determine distances between fusible signatures and fusible reference signatures;
join the representations into a combined representation while altering at least one value in at least one fusible reference signature to minimize difference measures between equivalent fusible reference signatures;
arrange documents in the combined representation according to each document's fusible signature while altering at least one value in at least one fusible signature to minimize changes to the distances; and
populate a new vector for each document to generate a fused signature, wherein the new vector for a given document comprises values from the given document's fusible signature after said arranging.
